(19) United States
(12) Patent Application Publication
(10) Pub. No.: US 2010/0040838 A1
(43) Pub. Date: Feb. 18, 2010

(54) Hardmask Process for Forming a Reverse Tone Image

(76) Inventors: David J. Abdallah, Bernardsville, NJ (US); Ralph R. Dammel, Flemington, NJ (US); Mark Neisser, Whitehouse Station, NJ (US)

Correspondence Address: SANGYA JAIN;AZ ELECTRONIC MATERIALS USA CORP., 70 MEISTER AVENUE, SOMERVILLE, NJ, 08876, US

(21) Appl. No.: 12/192,621

(22) Filed: Aug. 15, 2008

(51) Int. Cl. B44C 1/22; B32B 5/00

(52) U.S. Cl. 428/195.1; 216/51

(57) ABSTRACT

The present invention relates to a process for forming an reverse tone image on a device comprising; a) forming an absorbing underlayer on a substrate; b) forming a coating of a positive photoresist over the underlayer; c) forming a photoresist pattern; d) treating the first photoresist pattern with a hardening compound, thereby forming a hardened photoresist pattern; e) forming a silicon coating over the hardened photoresist pattern from a silicon coating composition; f) dry etching the silicon coating to remove the silicon coating till the silicon coating has about the same thickness as the photoresist pattern; and, g) dry etching to remove the photoresist and the underlayer, thereby forming a trench beneath the original position of the photoresist pattern. The invention further relates to a product of the above process and to a microelectronic device made from using the above process.

### FIELD OF THE INVENTION

The present invention relates to a process for forming fine patterns on a device using a reverse tone hard mask imaging process.

### DESCRIPTION

Photoresist compositions are used in microlithography processes for making miniaturized electronic components such as in the fabrication of computer chips and integrated circuits. Generally in these processes, a thin coating of film of a photoresist composition is first applied to a substrate material, such as silicon wafers used for making integrated circuits. The coated substrate is then baked to evaporate any solvent in the photoresist composition and to fix the coating onto the substrate. The photoresist coated on the substrate is next subjected to an image-wise exposure to radiation.

The radiation exposure causes a chemical transformation in the exposed areas of the coated surface. Visible light, ultraviolet (UV) light, electron beam, extreme ultraviolet (euv) and X-ray radiant energy are radiation types commonly used today in microlithographic processes. After this image-wise exposure, the coated substrate is optionally baked, and then treated with a developer solution to dissolve and remove either the radiation exposed (positive photoresist) or the unexposed areas of the photoresist (negative photoresist).

Positive working photoresists when they are exposed image-wise to radiation have those areas of the photoresist composition exposed to the radiation become more soluble to the developer solution while those areas not exposed remain relatively insoluble to the developer solution. Thus, treatment of an exposed positive-working photoresist with the developer causes removal of the exposed areas of the coating and the formation of a positive image in the photoresist coating. Again, a desired portion of the underlying surface is uncovered.

Photoresists sensitive to short wavelengths, between about 100 nm and about 300 nm, are often used where subhalfmicron geometries are required. Particularly preferred are deep uv photoresists sensitive at below 200 nm, e.g. 193 nm and 157 nm, comprising non-aromatic polymers, a photoacid generator, optionally a dissolution inhibitor, base quencher and solvent. High resolution, chemically amplified, deep ultraviolet (100-300 nm) positive tone photoresists are available for patterning images with less than quarter micron geometries.

Photoresists are also used to form narrow masked spaces on a substrate where the substrate is further etched to form trenches in the substrate. Hard mask patterning using positive photoresist has been found to give high resolution patterns over the substrate. However there is a need to provide for very narrow and deep trenches in the substrate using positive photoresists.

The present invention relates to a method of forming a pattern on a device such that a reverse tone pattern is formed on a substrate, the process uses a positive photoresist pattern which is frozen with a hardening compound together with hard mask technology. The freezing of the photoresist allows for a wide range of hard mask materials to be used since the solvent of the hard mask coating composition does not dissolve the frozen photoresist, whereas it would dissolve the unfrozen photoresist and thus be incompatible. Hard mask technology allows for the formation of very deep and narrow trenches to be formed in the substrate.

### SUMMARY OF THE INVENTION

The present invention relates to a process for forming a reverse tone image on a device comprising;

a) forming an absorbing underlayer on a substrate;

b) forming a coating of a positive photoresist over the underlayer;

c) imagewise exposing and developing the positive photoresist, thereby forming a photoresist pattern;

d) treating the photoresist pattern with a hardening compound, thereby forming a hardened photoresist pattern;

e) forming a silicon coating over the hardened photoresist pattern from a silicon coating composition, where the silicon coating is thicker than the photoresist pattern, and further where the silicon coating composition comprises a silicon polymer and an organic coating solvent;

f) dry etching the silicon coating to remove the silicon coating till the silicon coating has about the same thickness as the photoresist pattern; and,

g) dry etching to remove the photoresist and the underlayer, thereby forming a trench beneath the original position of the photoresist pattern.

The hardening compound may comprise at least 2 amino (NH₂) groups.

The hardening compound may have the structure (1),

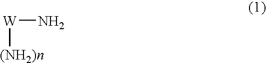

where, W is a C₁-C₈ alkylene, and n is 1-3.

The invention further relates to a product of the above process and to a microelectronic device made from using the above process.

### BRIEF DESCRIPTION OF THE DRAWINGS

FIG. 1 shows the substrate with an underlayer coating (layer 1).

FIG. 2 shows the substrate with a coating of the underlayer and the photoresist (layer 2).

FIG. 3 shows the imaged photoresist over the underlayer.

FIG. 4 shows the frozen photoresist pattern over the underlayer.

FIG. 5 shows the silicon layer (layer 3) coated over the frozen photoresist pattern and underlayer.

FIG. 6 shows the silicon layer has been etched back to where the silicon layer has about the same thickness as the photoresist pattern.

FIG. 7 shows the reverse tone hard mask after the removal of the photoresist pattern.

FIG. 8 shows the reverse tone hard mask after the transfer of the image in the silicon layer to the underlayer to form the reverse tone hardmask for etching the substrate.

FIG. 9 shows a design of a photoresist hardening chamber.

### DETAILED DESCRIPTION OF THE INVENTION

The present invention relates to an inventive process for imaging fine patterns on an electronic device, especially a microelectronic device, using a reverse tone trilayer imaging process comprising a method of freezing a positive photoresist. The present invention also relates to the product made using the inventive process and further relates to a microelectronic device made from the inventive process.

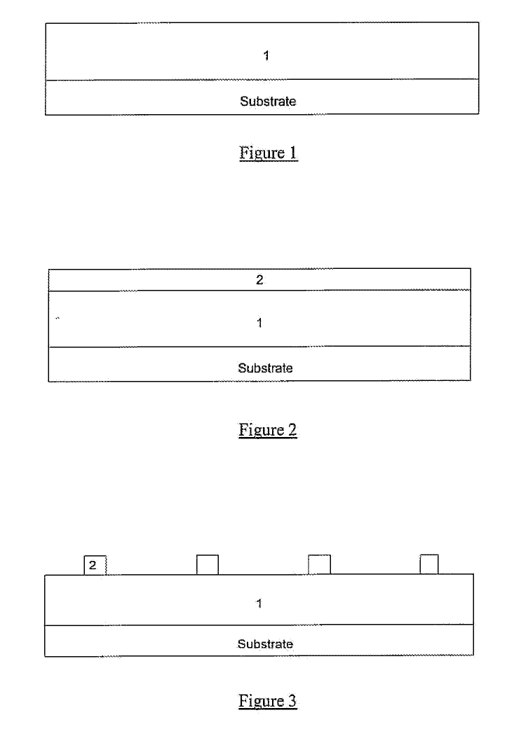

Specifically the present invention relates to a process for forming a reverse tone image on a device, and referring to FIGS. 1-8, comprising;

a) forming an absorbing underlayer (1) on a substrate;

b) forming a coating of a positive photoresist (2) over the underlayer;

c) imagewise exposing and developing the positive photoresist, thereby forming a photoresist pattern;

d) treating the first photoresist pattern with a hardening compound, thereby forming a hardened photoresist pattern (2 frozen);

e) forming a silicon coating (3) over the hardened photoresist pattern from a silicon coating composition, where the silicon coating is thicker than the photoresist pattern, and further where the silicon coating composition comprises a silicon polymer and an organic coating solvent;

f) dry etching the silicon coating to remove the silicon coating till the silicon coating has about the same thickness as the photoresist pattern; and,

g) dry etching to remove the photoresist and the underlayer, thereby forming a deep trench (4) beneath the original position of the photoresist pattern.

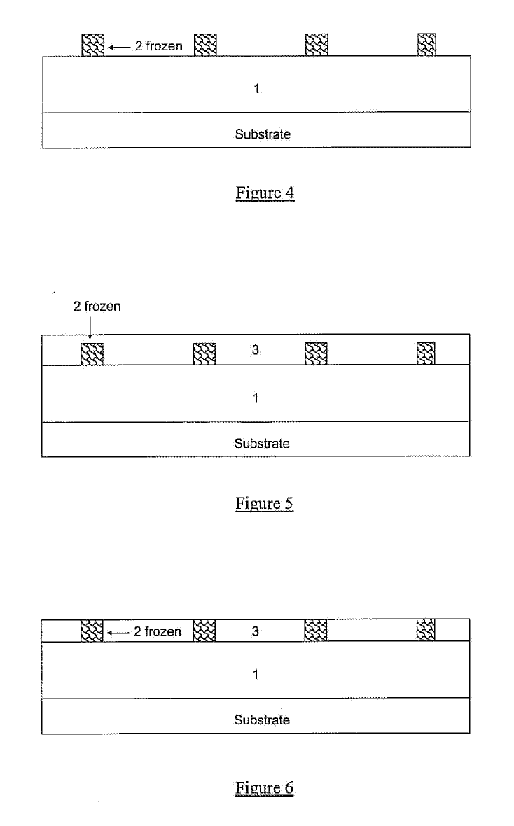

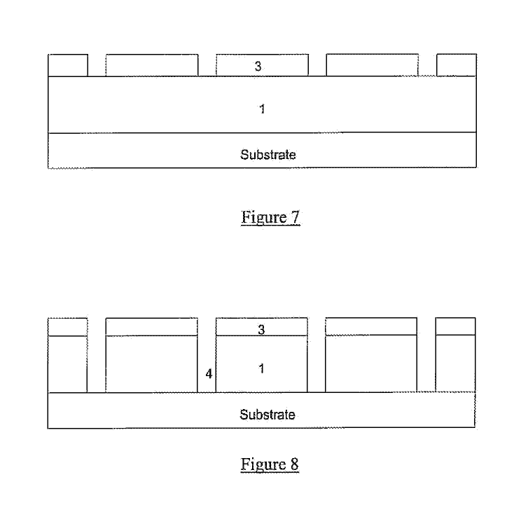

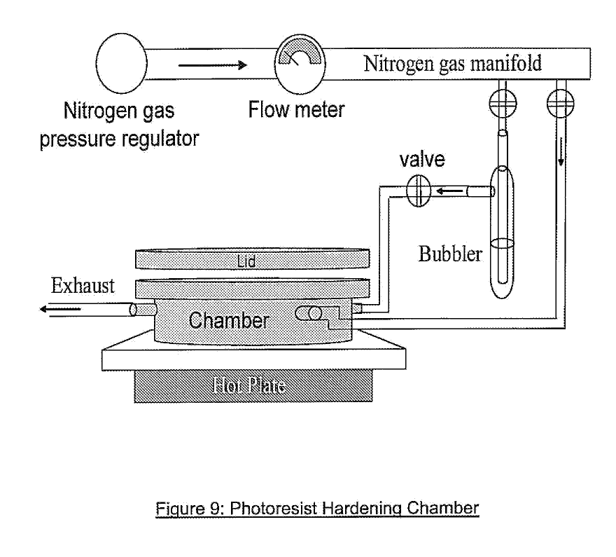

FIGS. 1-8 briefly describe the present inventive process of forming the reverse tone hard mask. A relatively thick layer of an absorbing underlayer coating (1) is formed on a substrate as in FIG. 1. The underlayer is then coated with a positive photoresist layer (2) as in FIG. 2. The photoresist is patterned comprising the steps of imagewise exposing and developing to form a photoresist pattern as in FIG. 3. The photoresist pattern is then frozen or crosslinked (2 frozen) using a hardening compound in order to prevent flow as shown in FIG. 4. In one embodiment the hardening compound may comprise at least 2 amino (NH2) groups. After the freezing process a silicon layer (3) from a silicon composition is formed to give a film thickness greater than the film thickness of the photoresist pattern in the patterned area as in FIG. 5. The silicon layer is then etched back using a dry etching process to reduce the silicon layer to thickness approximately equal to the thickness of the photoresist pattern (FIG. 6), that is, the photoresist surface is now visible. A reverse tone pattern is formed by removing the photoresist pattern using another dry etching process to form a pattern of silicon coating which forms a silicon hard mask for the further etching of the organic underlayer (FIG. 7). The underlayer can then be further patterned by a dry etching process (FIG. 8) with the use of the patterned silicon hard mask, thus forming a deep reverse tone pattern relative to the positive photoresist pattern over the substrate. A deep trench (4) is formed in the silicon/underlayer coating underneath where the positive photoresist pattern used to be, that is, a reverse tone hard mask is formed as shown in FIG. 8. The substrate is further etched to form the desired high resolution trench in the substrate using the silicon/underlayer pattern as a hard mask. The photoresist and the underlayer may be etched in separate dry etching steps or in one continuous dry etching step since both the photoresist and the underlayer are highly carbonaceous organic materials which are etchable with a gas comprising oxygen and/or hydrogen.

The substrates over which the underlayer coating is formed can be any of those typically used in the semiconductor industry. Suitable substrates include, without limitation, silicon, silicon substrate coated with a metal surface, copper coated silicon wafer, copper, aluminum, polymeric resins, silicon dioxide, metals, doped silicon dioxide, silicon nitride, silicon oxynitride, quartz, fused silica, sapphire, organic polymers, borosilicate glass, tantalum, polysilicon, ceramics, aluminum/copper mixtures; gallium arsenide and other such Group III/V compounds. The substrate may comprise any number of layers made from the materials described above. The coatings may be inorganic, organic or mixture of these. The substrate may be those useful in integrated circuits or MEMS devices.

The underlayer coating (layer 1 in FIGS. 1-8) formed on the substrate is typically any bottom antireflective coating composition. The bottom antireflective coating or underlayer may be organic spin coatable or it may be deposited by chemical vapor deposition (such as amorphous carbon). Typically, the organic spin coatable underlayer composition comprises an underlayer polymer which may be absorbing or nonabsorbing, and an organic solvent. The composition may further comprise additives selected from a thermal acid generator, a dye, a crosslinker, a photoacid generator, a surfactant, a secondary organic polymer and mixtures thereof. Examples of suitable underlayers include typical bottom anti-reflective coatings such as those described in the following US patent applications and patents: styrene polymers (US 2003/0220431, U.S. Pat. No. 6,114,085); acrylate polymers (US 2002/0137826, US 2002/0128410, US 2002/0156148); polyesters (US 2004/0209200, US 2002/0028408); polyurethane (US 2004/0023156); those with non-aromatic dyes (US 2002/0045125, US 2004/0067441); and molecular type coatings (US 2004/0110089) which are incorporated herein by reference in their entirety. The thickness of the underlayer is greater then the thickness of the photoresist coated above the underlayer. In one embodiment of the underlayer, the underlayer has carbon content greater than 80 weight %. Such high carbon content coatings are described in US patent application with Ser. No. 11/872,962 filed Oct. 16, 2008, Ser. No. 12/060,307 filed Apr. 1, 2008, Ser. No. 12/115,776 filed May 6, 2008; also U.S. Pat. No. 6,686,124, U.S. Pat. No. 6,737,492, and US 2003/0204035 and all of which are incorporated herein in their entirety by reference.

In one embodiment of the underlayer polymer, the polymer may be an acrylate polymer with a chromophore of at least 2 fused rings pendant from the backbone of the polymer, for example naphthyl and/or anthracyl group. The monomeric units may be derived from monomers such as 9-anthracenylmethyl methacrylate, 2-hydroxypropylmethacrylate, acetoxyethyl methacrylate, n-butylmethacrylate and their equivalents. An example is poly(9-anthracenylmethyl methacrylate/2-hydroxypropylmethacrylate/acetoxyethyl methacrylate/n-butylmethacrylate).

In another embodiment of the underlayer polymer, the polymer may comprise at least 3 fused rings in the backbone of the polymer. The fused aromatic unit may have in the range of about 3 to about 8 aromatic rings. The underlayer polymer comprises at least one unit with three or more fused aromatic rings in the backbone of the polymer and at least one unit with an aliphatic moiety in the backbone of the polymer. Other comonomeric units may also be present, such as substituted or unsubstituted phenyl, or substituted or unsubstituted naphthyl. In one embodiment the polymer may be free of any phenyl or single ring aromatic moiety. The fused aromatic rings provide the absorption for the coating, and are the absorbing chromophore. The fused aromatic rings of the polymer can comprise substituted or unsubstituted 6 membered aromatic rings which have a common bond to form a fused ring structure, such as units exemplified by structures 1-6 and their isomers,

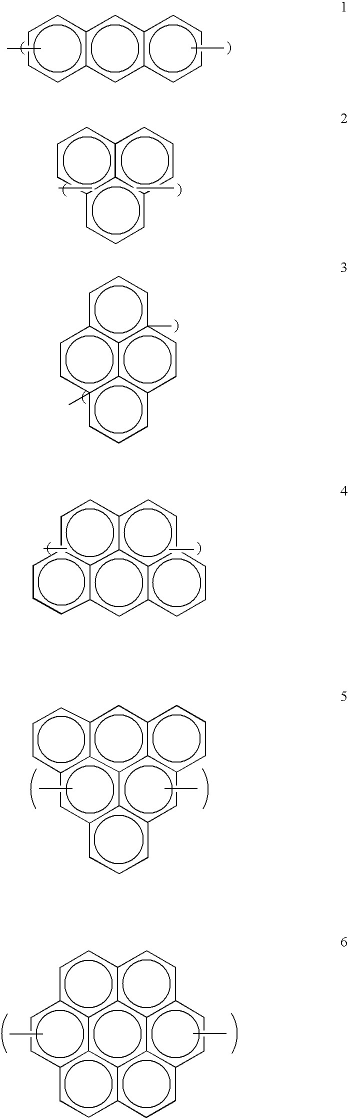

The fused rings may be exemplified by anthracene, phenanthrene, pyrene, fluoranthene, coronene triphenylene and their substituted derivatives.

The fused rings may form the backbone of the underlayer polymer at any site in the aromatic structure and the attachment sites may vary within the polymer. The fused ring structure can have more than 2 points of attachment forming a branched oligomer or branched polymer. In one embodiment of the underlayer polymer the number of fused aromatic rings may vary from 3-8, and in other embodiment of the polymer it comprises 4 or more fused aromatic rings, and more specifically the polymer may comprises pyrene as shown in structure 3. The fused aromatic rings may comprise one or more hetero-aromatic rings, where the heteroatom may be nitrogen or sulfur, as illustrated by structure 7.

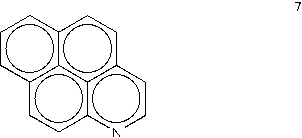

In one embodiment of the underlayer polymer, the polymer comprises the fused aromatic unit described previously and further, in order to isolate the chromophore, the fused aromatic unit is connected to an aliphatic carbon moiety. The fused aromatic rings of the polymer may be unsubstituted or substituted with one or more organo substituents, such as alkyl, alkylaryl, ethers, haloalkyls, carboxylic acid, ester of carboxylic acid, alkylcarbonates, alkylaldehydes, ketones. Further examples of substituents are —CH₂—OH, —CH₂Cl, —CH₂Br, —CH₂Oalkyl, —CH₂—O—C═O(alkyl), —CH₂—O—C═O(O-alkyl), —CH(alkyl)-OH, —CH(alkyl)-Cl, —CH(alkyl)-Br, —CH(alkyl)-O-alkyl, —CH(alkyl)-O—C═O-alkyl, —CH(alkyl)-O—C═O(O-alkyl), —HC═O, -alkyl-CO₂H, alkyl-C═O(O-alkyl), -alkyl-OH, -alkyl-halo, -alkyl-O—C═O(alkyl), -alkyl-O—C═O(O-alkyl), alkyl-HC═O. In one embodiment of the polymer, the fused aromatic group is free of any pendant moeity containing nitrogen. The substituents on the aromatic rings may aid in the solubility of the polymer in the coating solvent. Some of the substituents on the fused aromatic structure may also be thermolysed during curing, such that they may not remain in the cured coating and may still give a high carbon content film useful during the etching process. The fused aromatic groups are more generally illustrated by structures 1′ to 6′, where Rₐ is an organo substituent, such as hydrogen, hydroxy, hydroxy alkylaryl, alkyl, alkylaryl, carboxylic acid, ester of carboxylic acid, etc., and n is the number of substituents on the rings. The substituents, n, may range from 1-12. Typically n can range from 1-5, where Ra, exclusive of hydrogen, is a substituent independently selected from groups such as alkyl, hydroxy, hydroxyalkyl, hydroxyalkylaryl, alkylaryl, ethers, haloalkyls, alkoxy, carboxylic acid, ester of carboxylic acid, alkylcarbonates, alkylaldehydes, ketones. Further examples of substituents are —CH₂—OH, —OH₂Cl, —CH₂Br, —CH₂Oalkyl, —CH₂—O—C═O(alkyl), —CH₂—O—C═O(O-alkyl), —CH(alkyl)-OH, —CH(alkyl)-Cl, —CH(alkyl)-Br, —CH(alkyl)-O-alkyl, —CH(alkyl)-O—C═O-alkyl, —CH(alkyl)-O—C═O(O-alkyl), —HC═O, alkyl-CO₂H, alkyl-C═O(O-alkyl), -alkyl-OH, -alkyl-halo, -alkyl-O—O═O(alkyl), -alkyl-O—C═O(O-alkyl), alkyl-HC═O.

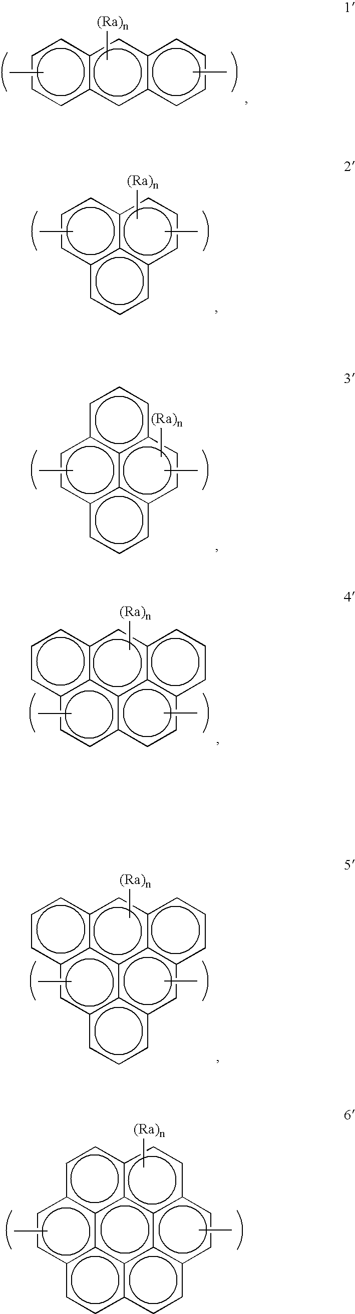

The polymer may comprise more than one type of the fused aromatic structures described herein.

In addition to the fused aromatic unit described above, the underlayer polymer of the novel antireflective coating further comprises at least one unit with an essentially aliphatic moiety in the backbone of the polymer, and the moiety is any that has a nonaromatic structure that forms the backbone of the polymer, such as an alkylene which is primarily a carbon/hydrogen nonaromatic moiety.

The polymer can comprise at least one unit which forms only an aliphatic backbone in the polymer, and the polymer may be described by comprising units, -(A)- and —(B)—, where A is any fused aromatic unit described previously, which may be linear or branched, and where B has only an aliphatic backbone. B may further have pendant substituted or unsubstituted aryl or aralkyl groups or be connected to form a branched polymer. The alkylene, aliphatic moiety in the polymer may be selected from a moiety which is linear, branched, cyclic or a mixture thereof. Multiple types of the alkylene units may be in the polymer. The alkylene backbone unit may have some pendant groups present, such as hydroxy, hydroxyalkyl, alkyl, alkene, alkenealkyl, alkylalkyne, alkyne, alkoxy, aryl, alkylaryl, aralkyl ester, ether, carbonate, halo (e.g. Cl, Br). Pendant groups can impart useful properties to the polymer. Some of the pendant groups may be thermally eliminated during curing to give a polymer with high carbon content, for example through crosslinking or elimination to form an unsaturated bond. Alkylene groups such as hydroxyadamantylene, hydroxycyclohexylene, olefinic cycloaliphatic moiety, may be present in the backbone of the polymer. These groups can also provide crosslinking sites for crosslinking the polymer during the curing step. Pendant groups on the alkylene moiety, such as those described previously, can enhance solubility of the polymer in organic solvents, such as coating solvents of the composition or solvents useful for edge bead removal. More specific groups of the aliphatic comonomeric unit are exemplified by adamantylene, dicyclopentylene, and hydroxy adamantylene. Different or the same alkylene group may be connected together to form a block unit and this block unit may be then connected to the unit comprising the fused aromatic rings. In some cases a block copolymer may be formed, in some case a random copolymer may be formed, and in other cases alternating copolymers may be formed. The copolymer may comprise at least 2 different aliphatic comonomeric units. The copolymer may comprise at least 2 different fused aromatic moieties. In one embodiment the polymer may comprise at least 2 different aliphatic comonomeric units and at least 2 different fused aromatic moieties. In another embodiment of the invention the polymer comprises at least one fused aromatic unit and aliphatic unit(s) free of aromatics. In one embodiment of the unit with the aliphatic group, the cycloalkylene group is selected from a biscycloalkylene group, a triscycloalkylene group, a tetracycloalkylene group in which the linkage to the polymer backbone is through the cyclic structure and these cyclic structures form either a monocyclic, a dicyclic or tricyclic structure. In another embodiment of the second polymer, the polymer comprises a unit with the fused aromatic rings and a unit with an aliphatic moiety in the backbone, where the aliphatic moiety is a mixture of unsubstituted alkylene and a substituted alkylene where the substituent may be hydroxy, carboxylic acid, carboxylic ester, alkylether, alkoxy alkyl, alkylaryl, ethers, haloalkyls, alkylcarbonates, alkylaldehydes, ketones and mixtures thereof.

In another embodiment of the underlayer polymer, it comprises at least one unit with 3 or more fused aromatic rings in the backbone of the polymer, at least one unit with an aliphatic moiety in the backbone of the polymer, and at least one unit comprising a group selected from a substituted phenyl, unsubstituted phenyl, unsubstituted biphenyl, substituted biphenyl, substituted naphthyl and unsubstituted naphthyl. The fused aromatic ring with 3 or more aromatic units and the aliphatic moiety are as described herein. The polymer may be free of any pendant moiety containing nitrogen. The polymer may be free of any pendant moiety containing nitrogen, in one embodiment. The substituents on the phenyl, biphenyl and naphthyl may be at least one polar group that increases the solubility of the polymer in a polar solvent, such as ethyl lactate, propyleneglycol monomethylether acetate (PGMEA) and propyleneglycol monomethyether (PGME). Examples of substituents are hydroxy, hydroxyalkyl, halide, etc. The phenyl, biphenyl or naphthyl group may form part of the backbone or be attached to the polymer backbone directly or through a linking group such as a adamantyl group, ethylene group, etc., and where examples of monomeric units may be derived from monomers such as hydroxystyrene, phenol, naphthol, and hydroxynaphthylene. The incorporation of phenol and/or naphthol moieties in the polymer backbone is preferred for films with high carbon content. The amount of the substituted phenylene, unsubstituted phenylene, unsubstituted biphenylene, substituted biphenylene, substituted naphthylene or unsubstituted naphthylene may range from about 5 mole % to about 50 mole % in the polymer, or from about 20 mole % to about 45 mole % in the polymer. Compositions comprising polymers of the present invention which further comprise phenolic and/or naphthol groups are useful when the coating solvent of the composition is PGMEA or a mixture of PGMEA and PGME. Compositions comprising polymers of the present invention which further comprise phenolic and/or naphthol groups are also useful when the excess composition is to be removed with an edgebead remover, especially where the edgebead remover comprises PGMEA or a mixture of PGMEA and PGME. Other edgebead removers comprising ethyl lactate may also be used. In one embodiment the composition comprises a polymer comprising at least one unit with 3 or more fused aromatic rings in the backbone of the polymer, at least one unit with an aliphatic moiety in the backbone of the polymer, and at least one unit comprising a group selected from phenol, naphthol and mixtures thereof. Pyrene, as the fused aromatic moiety, may be used. The composition may further contain a solvent comprising PGMEA. Other additives, as described herein, may be used in the composition.

The weight average molecular weight of the underlayer polymer can range from about 1,000 to about 50,000, or about 1300 to about 20,000. The carbon content of the polymer may be greater than 80% as measured by elemental analysis, preferably greater than 85%. The carbon content of the novel antireflective coating composition is greater than 80 weight % or greater than 85 weight % as measured by elemental analysis. A high carbon material allows for faster dry etching of the underlayer thus allowing a thicker hard mask layer to remain over the substrate. Other known types of absorbing antireflective coatings that can act as an underlayer may also be used. Absorbing antireflective coatings films with a carbon content of greater than 80 weight % are useful.

The underlayer may have a coating in the range of about 150 nm to about 800 nm. The exact thickness is determined by the type of etching process desired and the composition of the underlayer coating. The refractive index (n) of the underlayer is typically in the range of the photoresist which is coated above it and can range from about 1.6 to about 1.85 for dry lithography and for immersion lithography, especially for 193 nm and 248 nm. The absorption value (k) is in the range of about 0.1 to about 0.3 depending on the film thickness of the underlayer, typically referred to as a low absorption material. The n and k values can be calculated using an ellipsometer, such as the J. A. Woollam WVASE VU-32™ Ellipsometer. The exact values of the optimum ranges for k and n are dependent on the exposure wavelength used and the type of application.

The organic spin coatable antireflective underlayer coating composition is coated on the substrate using techniques well known to those skilled in the art, such as dipping, spin coating or spraying. The coating is further heated on a hot plate or convection oven for a sufficient length of time to remove any residual solvent and induce crosslinking, and thus insolubilizing the antireflective coating to prevent intermixing between the antireflective coating and the layer to be coated above it. The preferred range of temperature is from about 90° C. to about 280° C.

A positive photoresist layer (layer 2 in FIGS. 2-6) is formed over the underlayer and the particular photoresist used can be any of the types used in the semiconductor industry, provided the photoactive compound in the photoresist and the antireflective underlayer coating substantially absorb at the exposure wavelength used for the imaging process. Generally positive photoresists are preferred over negative photoresists since they provide higher resolution patterns and are more commonly available.

The present process is particularly suited to deep ultraviolet exposure. Typically chemically amplified photoresists are used. They may be positive photoresists. To date, there are several major radiation exposure technologies that have provided significant advancement in miniaturization, and these are radiation of 248 nm, 193 nm, 157 and 13.5 nm. Photoresists for 248 nm have typically been based on substituted polyhydroxystyrene and its copolymers/onium salts, such as those described in U.S. Pat. No. 4,491,628 and U.S. Pat. No. 5,350,660. On the other hand, photoresists for exposure below 200 nm require non-aromatic polymers since aromatics are opaque at this wavelength. U.S. Pat. No. 5,843,624 and U.S. Pat. No. 6,866,984 disclose photoresists useful for 193 nm exposure. Generally, polymers containing alicyclic hydrocarbons are used for photoresists for exposure below 200 nm. Alicyclic hydrocarbons are incorporated into the polymer for many reasons, primarily since they have relatively high carbon to hydrogen ratios which improve etch resistance, they also provide transparency at low wavelengths and they have relatively high glass transition temperatures. U.S. Pat. No. 5,843,624 discloses polymers for photoresist that are obtained by free radical polymerization of maleic anhydride and unsaturated cyclic monomers. Any of the known types of 193 nm photoresists may be used, such as those described in U.S. Pat. No. 6,447,980 and U.S. Pat. No. 6,723,488, and incorporated herein by reference.

Two basic classes of photoresists sensitive at 157 nm, and based on fluorinated polymers with pendant fluoroalcohol groups, are known to be substantially transparent at that wavelength. One class of 157 nm fluoroalcohol photoresists is derived from polymers containing groups such as fluorinated-norbornenes, and are homopolymerized or copolymerized with other transparent monomers such as tetrafluoroethylene (U.S. Pat. No. 6,790,587, and U.S. Pat. No. 6,849,377) using either metal catalyzed or radical polymerization. Generally, these materials give higher absorbencies but have good plasma etch resistance due to their high alicyclic content. More recently, a class of 157 nm fluoroalcohol polymers was described in which the polymer backbone is derived from the cyclopolymerization of an asymmetrical diene such as 1,1,2,3,3-pentafluoro-4-trifluoromethyl-4-hydroxy-1,6-heptadiene (U.S. Pat. No. 6,818,258) or copolymerization of a fluorodiene with an olefin (U.S. Pat. No. 6,916,590). These materials give acceptable absorbance at 157 nm, but due to their lower alicyclic content as compared to the fluoro-norbornene polymer, have lower plasma etch resistance. These two classes of polymers can often be blended to provide a balance between the high etch resistance of the first polymer type and the high transparency at 157 nm of the second polymer type. Photoresists that absorb extreme ultraviolet radiation (EUV) of 13.5 nm are also useful and are known in the art. Also useful are e-beam photoresists. Photoresists sensitive to 365 nm and 436 nm may also be used. At the present time 193 nm and EUV photoresists are preferred.

The solid components of the photoresist composition are mixed with a solvent or mixtures of solvents that dissolve the solid components of the photoresist. Suitable solvents for the photoresist may include, for example, a glycol ether derivative such as ethyl cellosolve, methyl cellosolve, propylene glycol monomethyl ether, diethylene glycol monomethyl ether, diethylene glycol monoethyl ether, dipropylene glycol dimethyl ether, propylene glycol n-propyl ether, or diethylene glycol dimethyl ether; a glycol ether ester derivative such as ethyl cellosolve acetate, methyl cellosolve acetate, or propylene glycol monomethyl ether acetate; carboxylates such as ethyl acetate, n-butyl acetate and aryl acetate; carboxylates of di-basic acids such as diethyloxylate and diethylmalonate; dicarboxylates of glycols such as ethylene glycol diacetate, and propylene glycol diacetate; and hydroxy carboxylates such as methyl lactate, ethyl lactate, ethyl glycolate, and ethyl-3-hydroxy propionate, a ketone ester such as methyl pyruvate or ethyl pyruvate; an alkoxycarboxylic acid ester such as methyl3-methoxypropionate, ethyl3-ethoxypropionate, ethyl2-hydroxy-2-methylpropionate, or methylethoxypropionate; a ketone derivative such as methyl ethyl ketone, acetyl acetone, cyclopentanone, cyclohexanone or 2-heptanone; a ketone ether derivative such as diacetone alcohol methyl ether; a ketone alcohol derivative such as acetol or diacetone alcohol; a ketal or acetal like 1,3dioxalone and diethoxypropane; lactones such as butyrolactone; an amide derivative such as dimethylacetamide or dimethylformamide, anisole, and mixtures thereof. Typical solvents for photoresist, used as mixtures or alone, that can be used, without limitation, are propylene glycol monomethyl ether acetate (PGMEA), propylene gycol monomethyl ether (PGME), and ethyl lactate (EL), 2-heptanone, cyclopentanone, cyclohexanone, and gamma butyrolactone, but PGME, PGMEA and EL or mixtures thereof are preferred. Solvents with a lower degree of toxicity, good coating and solubility properties are generally preferred.

In one embodiment of the process a photoresist sensitive to 193 nm is used. The photoresist comprises a polymer, a photoacid generator, and a solvent. The polymer is an (meth)acrylate polymer which is insoluble in ah aqueous alkaline developer. Such polymers may comprise units derived from the polymerization of monomers such as alicyclic(meth)acrylates, mevalonic lactone methacrylate, 2-methyl-2-adamantyl methacrylate, 2-adamantyl methacrylate (AdMA), 2-methyl-2-adamantyl acrylate (MAdA), 2-ethyl-2-adamantyl methacrylate (EAdMA), 3,5-dimethyl-7-hydroxy adamantyl methacrylate (DMHAdMA), isoadamantyl methacrylate, hydroxy-1-methacryloxyadamatane (HAdMA; for example, hydroxy at the 3-position), hydroxy-1-adamantyl acrylate (HADA; for example, hydroxy at the 3-position), ethylcyclopentylacrylate (ECPA), ethylcyclopentylmethacrylate (ECPMA), tricyclo[5,2,1,0^{2,6}]deca-8-yl methacrylate (TCDMA), 3,5-dihydroxy-1-methacryloxyadamatane (DHAdMA), β-methacryloxy-γ-butyrolactone, α- or β-gamma-butyrolactone methacrylate (either α- or β-GBLMA), 5-methacryloyloxy-2,6-norbornanecarbolactone (MNBL), 5-acryloyloxy-2,6-norbornanecarbolactone (ANBL), isobutyl methacrylate (IBMA), α-gamma-butyrolactone acrylate (α-GBLA), spirolactone(meth)acrylate, oxytricyclodeeane(meth)acrylate, adamantane lactone(meth)acrylate, and α-methacryloxy-γ-butyrolactone, among others. Examples of polymers formed with these monomers include poly(2-methyl-2-adamantyl methacrylate-co-2-ethyl-2-adamantyl methacrylate-co-3-hydroxy-1-methacryloxyadamantane-co-3-gamma-butyrolactone methacrylate); poly(2-ethyl-2-adamantyl methacrylate-co-3-hydroxy-1-methacryloxyadamantane-co-β-gamma-butyrolactone methacrylate); poly(2-methyl-2-adamantyl methacrylate-co-3-hydroxy-1-methacryloxyadamantane-co-β-gamma-butyrolactone methacrylate); poly(t-butyl norbornene carboxylate-co-maleic anhydride-co-2-methyl-2-adamantyl methacrylate-co-β-gamma-butyrolactone methacrylate-co-methacryloyloxy norbornene methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-ethyl-2-adamantyl methacrylate-co-3-hydroxy-1-adamantyl acrylate-co-β-gamma-butyrolactone methacrylate); poly(2-ethyl-2-adamantyl methacrylate-co-3-hydroxy-1-adamantyl acrylate-co-α-gamma-butyrolactone methacrylate-co-tricyclo[5,2,1,0^{2,6}]deca-8-yl methacrylate); poly(2-methyl-2-adamantyl methacrylate-co-3,5-dihydroxy-1-methacryloxyadamantane-co-α-gamma-butyrolactone methacrylate); poly(2-methyl-2-adamantyl methacrylate-co-3,5-dimethyl-7-hydroxy adamantyl methacrylate-co-α-gamma-butyrolactone methacrylate); poly(2-methyl-2-adamantyl acrylate-co-3-hydroxy-1-methacryloxyadamantane-co-α-gamma-butyrolactone methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-methyl-2-adamantyl methacrylate-co-β-gamma-butyrolactone methacrylate-co3-hydroxy-1-methacryloxyadamantane-co-ethylcyclopentylacrylate); poly(2-methyl-2-adamantyl methacrylate-co-3-hydroxy-1-adamantyl acrylate-co-α-gamma-butyrolactone methacrylate); poly(2-methyl-2-adamantyl methacrylate-co-3-hydroxy-1-methacryloxyadamantane-co-α-gamma-butyrolactone methacrylate-co-2-ethyl-2-adamantyl methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-methyl-2-adamantyl methacrylate-co-2-ethyl-2-adamantyl methacrylate-co-β-gamma-butyrolactone methacrylate-co-3-hydroxy-1-methacryloxyadamantane); poly(2-methyl-2-adamantyl methacrylate-co-2-ethyl-2-adamantyl methacrylate-co-α-gamma-butyrolactone methacrylate-co-3-hydroxy-1-methacryloxyadamantane); poly(2-methyl-2-adamantyl methacrylate-co-methacryloyloxy norbornene methacrylate-co-β-gamma-butyrolactone methacrylate); poly(ethylcyclopentylmethacrylate-co-2-ethyl-2-adamantyl methacrylate-co-α-gamma-butyrolactone acrylate); poly(2-ethyl-2-adamantyl methacrylate-co-3-hydroxy-1-adamantyl acrylate-co-isobutyl methacrylate-co-α-gamma-butyrolactone acrylate); poly(2-methyl-2-adamantyl methacrylate-co-β-gamma-butyrolactone methacrylate-co-3-hydroxy-1-adamantyl acrylate-co-tricyclo[5,2,1,02,6]deca-8-yl methacrylate); poly(2-ethyl-2-adamantyl methacrylate-co-3-hydroxy-1-adamantyl acrylate-co-α-gamma-butyrolactone acrylate); poly(2-methyl-2-adamantyl methacrylate-co-β-gamma-butyrolactone methacrylate-co-2-adamantyl methacrylate-co-3-hydroxy-1-methacryloxyadamatane); poly(2-methyl-2-adamantyl methacrylate-co-methacryloyloxy norbornene methacrylate-co-β-gamma-butyrolactone methacrylate-co-2-adamantyl methacrylate-co-3-hydroxy-1-methacryloxyadamatane); poly(2-methyl-2-adamantyl methacrylate-co-methacryloyloxy norbornene methacrylate-co-tricyclo[5,2,1,02,6]deca-8-yl methacrylate-co-3-hydroxy-1-methacryloxyadamatane-co-α-gamma-butyrolactone methacrylate); poly(2-ethyl-2-adamantyl methacrylate-co-3-hydroxy-1-adamantyl acrylate-co-tricyclo[5,2,1,02,6]deca-8-yl methacrylate-co-α-gamma-butyrolactone methacrylate); poly(2-ethyl-2-adamantyl methacrylate-co-3-hydroxy-1-adamantyl acrylate-co-α-gamma-butyrolactone acrylate); poly(2-methyl-2-adamantyl methacrylate-co-3-hydroxy-1-methacryloxyadamatane-co-α-gamma-butyrolactone methacrylate-co-2-ethyl-2-adamantyl-co-methacrylate); poly(2-ethyl-2-adamantyl methacrylate-co-3-hydroxy-1-adamantyl acrylate-co-α-gamma-butyrolactone methacrylate-co-tricyclo[5,2,1,0^{2,6}]deca-8-yl methacrylate); poly(2-ethyl-2-adamantyl methacrylate-co-3-hydroxy-1-adamantyl acrylate-co-α-gamma-butyrolactone methacrylate); poly(2-methyl-2-adamantyl methacrylate-co-3-hydroxy-1-adamantyl acrylate-co-5-acryloyloxy-2,6-norbornanecarbolactone); poly(2-ethyl-2-adamantyl methacrylate-co-3-hydroxy-1-adamantyl acrylate-co-α-gamma-butyrolactone methacrylate-co-α-gamma-butyrolactone acrylate); poly(2-ethyl-2-adamantyl methacrylate-co-3-hydroxy-1-adamantyl acrylate-co-α-gamma-butyrolactone methacrylate-co-2-adamantyl methacrylate); and poly(2-ethyl-2-adamantyl methacrylate-co-3-hydroxy-1-adamantyl acrylate-co-α-gamma-butyrolactone acrylate-co-tricyclo[5,2,1,02,6]deca-8-yl methacrylate). Photoresist polymers comprising at least one lactone group are preferred.

The photoresist may further comprise additives such as basic quenchers, surfactants, dyes, crosslinkers, etc. Useful photoresists are further exemplified and incorporated by reference in U.S. application with Ser. No. 11/834,490 filed Aug. 6, 2007 and US publication number US 2007/0015084.

After the coating process, the photoresist is patterned as is known in the art. Patterning comprises imagewise exposure with a radiation source and development. The exposure may be done using typical exposure equipment for the particular exposure source. The exposed photoresist is then developed in an aqueous developer to remove the treated photoresist. The developer is preferably an aqueous alkaline solution comprising, for example, tetramethyl ammonium hydroxide (TMAH). The developer may further comprise surfactant(s). An optional heating step can be incorporated into the process prior to development and after exposure. The process of coating and imaging photoresists is well known to those skilled in the art and is optimized for the specific type of photoresist used. Typically the thickness of the photoresist is in the range of about 50 nm to about 400 nm for 1.93 nm exposure. The photoresist patterning is determined by the photoresist used.

Once the photoresist pattern is formed, the photoresist pattern is then frozen or crosslinked (pattern 2 frozen in FIGS. 4-6) to prevent dissolution in typical organic solvents. The photoresist pattern is treated with a hardening compound to harden the photoresist so that the pattern becomes insoluble in the solvent of the silicon coating composition to be coated over the photoresist pattern. The use of the hardening compound to freeze the photoresist pattern allows for a wider range of photoresists to be used, such as photoresists comprising high Tg or low Tg polymers. Photoresists comprising acrylate polymers are useful for hardening treatment of the present invention, since most polymers have a Tg lower than 200° C. Photoresists comprising acrylate polymers with a lactone group are also useful. In one embodiment of the present invention the hardening of the photoresist pattern is done with a hardening amino compound comprising at least 2 amino (—NH₂) groups and simultaneously heating the photoresist pattern, thereby forming a hardened first photoresist pattern. Although not being bound by the theory, it is believed that the amino compound diffuses through the photoresist pattern and in the presence of heat crosslinks the photoresist, thereby forming a hardened or frozen pattern. The pattern becomes insoluble in the solvent of the silicon coating composition. The hardening treatment may be done on a hot plate with a chamber or an enclosed oven, with the vapor of the hardening compound. The hardening of the photoresist pattern may be done on a hotplate in an enclosed chamber where the amino compound is introduced in a vaporized form with a carrier gas like nitrogen, and the chamber further comprises a heating source to heat the patterned substrate in an enclosed atmosphere. In one case, the chamber comprises a hotplate for supporting the substrate, an inlet to introduce the amino compound, a purging inlet and an exhaust outlet. Purging may be done with gases such as nitrogen, argon or helium. FIG. 9 shows a typical chamber for hardening the pattern. Conditions such as the type of amino compound, the temperature and time of hardening, concentration of the amino compound, flow rate of the amino compound in a chamber, etc. are optimized to give the optimum degree of hardening. The extent of hardening can be determined by soaking the hardened photoresist in the test solvent to measure the loss of the film thickness of the treated photoresist. Minimal film thickness loss is desirable, where the film thickness loss of the treated photoresist in the solvent of the silicon composition is less than 10 nm, preferably less than 8 nm and more preferably less than 5 nm. Insufficient hardening will dissolve the photoresist. Specifically, the solvent may be selected from the solvent(s) of the photoresist described herein as an example. The hardening process is further described in U.S. applications filed on Apr. 2, 2008 with Ser. Nos. 12/061,061 and 12/061,111 which are incorporated herein in its entirety.

The hardening compound used may be any that hardens the photoresist. The hardening photoresist is insoluble in the solvent of the silicon composition. The hardened photoresist is also thermally nonflowing. The hardening compound may comprise at least 2 amino (NH₂) groups. The hardening compound may be exemplified by structure (8),

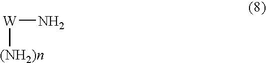

where, W is a C₁-C₈ alkylene, and n is 1-3. In one embodiment of the amino compound n=1. Alkylene refers to linear or branched. Preferably alkylene C₁-C₄. Examples of the amino compound are,
ethylenediamine H₂NCH₂CH₂NH₂
(1,2diaminoethane)

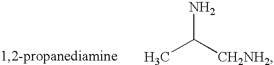

1,3-diaminopropane H₂NCH₂CH₂CH₂NH₂,
If the amino compound is used in a chamber, then a compound which can form a vapor is preferred. The amino compound may be used for hardening at temperatures in the range of about 25° C. to about 250° C., for about 30 seconds to about 20 minutes. The upper hardening temperature is preferably below the flow temperature of the photoresist pattern. Lower hardening temperatures require longer hardening times. The flow rate of the compound may range from about 1 to about 10 L/minute. The vapor pressure of the amino compound and/or its temperature can be increased to accelerate the hardening reaction. The use of the amino compound allows for lower hardening temperatures and lower hardening times than just a thermal hardening alone of the photoresist pattern.

An additional baking step may be included after the treatment step, which can induce further crosslinking and/or densification of the pattern and also to volatilize any residual gases in the film. The baking step may range in temperature from about 190° C. to about 250°C. Densification can lead to improved pattern profiles. After the appropriate amount of hardening of the photoresist, the photoresist pattern may optionally be treated with a cleaning solution. Examples of cleaning solutions can be edgebead removers for photoresists such as AZ®ArF Thinner or AZ®ArF MP Thinner available commercially, or any of the photoresist solvent(s).

After the hardening of the photoresist, a noncorformal silicon layer (layer 3) is formed over the photoresist pattern as shown in FIG. 5. The thickness of the silicon layer is thicker than the photoresist pattern and completely covers the pattern to form a fairly flat layer. Silicon compositions which can form planarizing layers are preferred. The thickness of the silicon layer (X nm) in the pattern region needs to be sufficient to cover the photoresist pattern height (Y nm), that is X>Y. As an example, the thickness of the photoresist pattern (Y) can range from about 20 nm to about 200 nm. The thickness of the silicon layer (X) can range from about 25 nm to about 300 nm depending on the thickness of the photoresist layer and the etching process. The difference of X and Y can be in the range of about 5 nm to about 50 nm. Any silicon containing spin-on-glass types of solutions may be used, such as those available from Honeywell, for example DUO248™ and the ACCUGLASSÂ® SOG—a series of methylsiloxane polymers. In one embodiment the silicon polymer of the silicon coating composition is a silsesquioxane polymer. Any of the silicon polymer described in patent applications US 2007/0298349, US 2008/0008954 and US 2005/0277058, and US patent application with Ser. No. 11/676,673 filed on Feb. 20, 2007 may be used and are incorporated by reference herein in their entirety. Another example are those described in WO 2006/065321. A typical silicon composition comprises a silicon polymer which is capable of forming a nonflowing film. As an example the silsesquioxane polymer may have pendent epoxy, isopropyl or phenyl groups. The composition may additionally contain a crosslinking catalyst, such as an ammonium salt or halide. The silicon content of the layer is greater than 18 weight %. The composition is spin coated and heated. Typical parameters of the silicon material used may be used to form the coating.

After the trilayer is formed, the substrate is placed in a dry etching chamber, where a gas mixture comprising a fluorinated hydrocarbon, such as CF₄, is used to etch back the silicon coating to close to the thickness of the photoresist pattern (FIG. 6), such that the top of the photoresist pattern is visible. The etch rate and etch rate selectivity to the photoresist can be controlled by adding other gases, such as oxygen. Sensors provide the endpoint for the etching or a timed etch can be used if the etch rate and the thickness of the film to be removed is known. Some small amount of the surface top layer of the photoresist pattern may be removed during the etch back process. Once the surface of the photoresist is visible the photoresist, the photoresist and the underlayer can be dry etched, thus reversing the tone of the photoresist pattern (FIG. 7-8). A gas comprising oxygen and/or hydrogen is useful for etching the photoresist and the underlayer. Additional gases such as argon, helium, xenon, krypton, neon, and combination thereof may be added. The gas mixture may further comprise of other gases such as nitrogen, carbon monoxide, carbon dioxide, sulfur dioxide, BCl₃, HBr, Cl₂ and a fluorine containing gas such as NF₃, SF₆, CF₄, or combinations thereof to improve the performance. The photoresist and the underlayer may be removed in a one continuous process or in 2 separate steps. An anisotropic etch is preferred for etching the photoresist and the underlayer.

The underlayer/silicon hard mask pattern of the inventive process can be used as a mask to dry etch the substrate to form a trench of the desired depth. The present novel process allows for the use of standard high resolution positive photoresists to be used to form reverse tone narrow trenches in the substrate. The process of dry etching is optimized for the appropriate substrate as in known in the art.

Unless otherwise indicated, all numbers expressing quantities of ingredients, properties such as molecular weight, reaction conditions, and so forth used in the specification and claims are to be understood as being modified in all instances by the term “about.” Each of the documents referred to above are incorporated herein by reference in its entirety, for all purposes. The following specific examples will provide detailed illustrations of the methods of producing and utilizing compositions of the present invention. These examples are not intended, however, to limit or restrict the scope of the invention in any way and should not be construed as providing conditions, parameters or values which must be utilized exclusively in order to practice the present invention.

### EXAMPLES

### Example 1

### Underlayer Formulation

A stock underlayer solution was made by taking 10 g of MX-270 (available from Sanwa Chemical Co., Tamura Hiratsuka-city Kanagawa Pref. Japan), 90 g of 70/30 poly(methyl methacrylate-co-hydroxystyrene) (available from DuPont, 1007 Market St. Wilmington, Del.) and 40 g of 10% dodecylbenzylsulfonium triethylammonium salt (in ArF Thinner) and 860 g ArF thinner (70:30 PGME:PGMEA).

A coating composition was prepared by diluting the stock solution with ArF thinner to a 1:1 ratio by weight. The coating solution was then filtered through 0.2 μm PTFE filter.

### Example 2

### Photoresist Formulation

AZ® AX2110P (available from AZ® Electronic Materials USA Corp, 70 Meister Aye., Somerville, N.J.) is diluted with AZ® ArF MP thinner to a 1:1 ratio by weight. The coating solution was then filtered through 0.2 μm PTFE filter.

### Example 3

### Spin-on-Glass (SOG) Formulation

2.5 g of poly(phenyl-methylsilsesquioxane) (SST-3PM1 available from Gelest Inc., 11 E Steel Rd., Morrisville, Pa.) was dissolved with 97.5 g AZ®ArF Thinner. The coating solution was then filtered through 0.2 μm PTFE filter.

### Example 4

### Reverse Tone Lithography Stack Preparation

The carbon underlayer coating from Example 1 was spin-coated onto a 8 inch silicon wafer at 1500 rpm and baked at 200° C. for 60 seconds to give a film thickness of 200 nm. Photoresist formulation from Example 2 was coated at 1500 rpm and softbaked at 100° C./60 sec to give a film thickness of 90 nm. This stack was exposed on an ArF scanner (Nikon NSR-306D: NA=0.85, Dipole Y Illumination, 0.8 s, a/R=0.63, Reticle: 6% HTPSM with a grating composed of 90 nm line space features) interfaced to a TEL Act 12″ track, and developed with AZ300MIF (available from AZ® Electronic Materials USA Corp, 70 Meister Ave., Somerville, N.J.) at 23° C. for 30 sec. The layers were postexposure baked at 110° C. for 60 sec. The cross-section from a scanning electron microscope (SEM) pictures of the wafers showed features of 45 nm lines with a 135 nm space were easily resolved.

The developed image was frozen in a Vapor Reaction Chamber (VRC) as depicted in FIG. 9 for 2 minutes with a nitrogen flow rate of 3 L/min flowing through a 250 mL bubbler filled with diaminoethane (H₂NCH₂GH₂NH₂). The bake temperature of the VRC was kept at 180° C.

The spin-on glass (SOG) formulation from Example 3 was coated over the frozen photoresist image with a spin speed of 1500 rpm and a subsequent bake at 110° C. for 60 seconds to give a film thickness of 90 nm.

### Example 5

### Pattern Transfer

To remove excess SOG film thickness, wafers with the reverse tone lithography stack were first subjected to a 5 second SOG etch back step. This was achieved using a 1:1 CF₄/O₂ etch gas combination with the other plasma conditions described in Table 1. The next etch step was the removal of the photoresist image and this was achieved using a oxygen rich etch. In addition to removing the photoresist, oxygen etching hardened the SOG by removing organics and forming SiO₂. Although the photoresist removal step does not require anisotropic etching (since the structure itself inherently incorporates the necessary anisotropy) an anisotropic O₂ etch process would allow the photoresist removal and the pattern transfer step of the SOG to the underlayer to be combined. A combined photoresist removal and underlayer pattern transfer etch step was achieved using a 15 second O₂ etch with the other plasma conditions described in Table 1.

The final etch pattern was a reverse image of the positive photoresist pattern and was also a much thicker and more etch resistant pattern than the photoresist pattern, thus allowing for a better pattern transfer into the substrate than the photoresist pattern.

TABLE 1
Optimized etch conditions for reverse tone hard mask pattern transfer steps.

| | | | | | | Top | Wafer |
|---|---|---|---|---|---|---|---|
| | O₂ | CF₄ | N₂ | Ar | Pressure | power | power |
| Transfer step | (SCCM) | (SCCM) | (SCCM) | (SCCM) | (Pa) | (W) | (W) |
| SOG etch back | 50 | 50 | — | — | 5.0 | 200 | 100 |
| Combined PR removal | 4 | — | 10 | 25 | 0.26 | 200 | 200 |
| and UL transfer step | | | | | | | |

Reverse tone hard mask etch recipes were optimized on a ULVAC NE-5000N using Inductively Super Magnetron (ISM) technology. Dual 13.56 MHz RF power sources allow for the generation of excited species to be partially decoupled from the substrates bias. A permanent, magnetic field helps to increase plasma ion density by confining electron to trajectories which increase the chance of collisions. Wafer temperatures are kept constant at 25° C. using 266 Pa He backside cooling.

1. A process for forming a reverse tone image on a device comprising;
a) forming an absorbing underlayer on a substrate;
b) forming a coating of a positive photoresist over the underlayer;
c) imagewise exposing and developing the positive photoresist, thereby forming a photoresist pattern;
d) treating the photoresist pattern with a hardening compound, thereby forming a hardened photoresist pattern;
e) forming a silicon coating over the hardened photoresist pattern from a silicon coating composition, where the silicon coating is thicker than the photoresist pattern, and further where the silicon coating composition comprises a silicon polymer and an organic coating solvent;
f) dry etching the silicon coating to remove the silicon coating till the silicon coating has about the same thickness as the photoresist pattern; and,
g) dry etching to remove the photoresist and the underlayer, thereby forming a trench beneath the original position of the photoresist pattern.

2. The process of claim 1, where the hardening compound comprises at least 2 amino (NH₂) groups.

3. The process of claim 1, further comprising a step of dry etching the substrate.

4. The process of claim 1 where in step g) the dry etching comprises using the same gas composition to remove the photoresist and the underlayer in one continuous step.

5. The process of claim 1 where in step g) the dry etching comprises first removing the photoresist followed by a separate step to remove the underlayer.

6. The process of claim 1, where the hardening compound has structure (1), 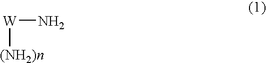
where, W is a C₁-C₈ alkylene, and n is 1-3.

7. The process of claim 1, where the hardening compound is selected from 1,2-diaminoethane, 1,3-propanediamine, and 1,5-diamino-2-methylpentane.

8. The process of claim 4, where n is 1.

9. The process of claim 1, where the treating step of the photoresist pattern is with a vaporized hardening compound.

10. The process of claim 1, where the treating step comprises a heating step.

11. The process of claim 1, where the treating step comprises heating the photoresist pattern in the presence of a vaporized hardening compound.

12. The process of claim 8, where the heating step is in the range of about 80° C. to about 225° C.

13. The process of claim 1, where the underlayer has a carbon content greater than 80 weight %.

14. The process of claim 1, where the imagewise exposure is selected from 248 nm, 193 nm, 157 nm, EUV and e-beam.

15. The process of claim 1, where silicon polymer of the silicon coating composition is a silsesquioxane polymer.

16. The process of claim 1, where organic solvent of the silicon coating composition is also a solvent for the untreated photoresist layer.

17. The process of claim 1, where the dry etching gas in step g) for removing the silicon layer comprises a fluorocarbon.

18. The process of claim 15, where the fluorocarbon is CF₄.

19. The process of claim 1, where the dry etching gas in step f) comprises oxygen.

20. A product using the process of claim 1.

21. A microelectronic device using a process for forming a reverse tone image on a device comprising;
a) forming an absorbing underlayer on a substrate;
b) forming a coating of a positive photoresist over the underlayer;
c) imagewise exposing and developing the positive photoresist thereby forming a photoresist pattern;
d) treating the first photoresist pattern with a hardening compound, thereby forming a hardened photoresist pattern;
e) forming a silicon coating over the photoresist pattern from a silicon coating composition, where the silicon coating is thicker than the photoresist pattern, further where the silicon coating comprises a silicon polymer and an organic coating solvent;
f) dry etching the silicon coating to remove the silicon coating to about the same thickness as the photoresist pattern; and,
g) dry etching the photoresist to remove the photoresist and the underlayer, thereby forming a trench beneath the original position of the photoresist pattern.
